(19) United States
(12) Patent Application Publication
(10) Pub. No.: US 2025/0303918 A1
(43) Pub. Date: Oct. 2, 2025

(54) CONTROL DEVICE, CONTROL METHOD, AND STORAGE MEDIUM

(71) Applicant: HONDA MOTOR CO., LTD., Tokyo (JP)

(72) Inventors: Takaharu Watanabe, Wako-shi (JP); Wataru Hoshikawa, Wako-shi (JP); Kota Ogasawara, Wako-shi (JP); Shiori Nakanishi, Wako-shi (JP); Pu Qian, Wako-shi (JP)

(21) Appl. No.: 19/056,799

(22) Filed: Feb. 19, 2025

(30) Foreign Application Priority Data
Mar. 28, 2024 (JP) 2024-053905

(51) Int. Cl. B60L 58/12; H01M 10/0525; H01M 10/44

(52) U.S. Cl. CPC B60L 58/12; H01M 10/0525; H01M 10/446; H01M 2220/20

(57) ABSTRACT

A control device includes a processor. The processor is configured to acquire charge-discharge-rate information regarding a charge-discharge rate during charge or discharge of a lithium metal battery including a negative electrode containing lithium, and determine charge-discharge content of the lithium metal battery based on the charge-discharge-rate information.

### CROSS-REFERENCE TO RELATED APPLICATION

Priority is claimed on Japanese Patent Application No. 2024-053905, filed Mar. 28, 2024, the content of which is incorporated herein by reference.

### BACKGROUND OF THE INVENTION

### Field of the Inventions

The present invention relates to a control device, a control method, and a storage medium.

### Description of Related Art

In recent years, research and development contributing to energy efficiency has been conducted to ensure that more people have access to affordable, reliable, sustainable, and advanced energy (for example, see PCT International Publication No. WO2023/118960, Japanese Unexamined Patent Application, First Publication No. 2023-17581, and Japanese Unexamined Patent Application, First Publication No. 2022-113377). With regard to such techniques, lithium metal batteries in which lithium metal is used for negative electrodes have gained interest as secondary batteries. A lithium metal battery includes a positive electrode, a negative electrode that includes a metallic lithium layer, and an electrolyte that is provided between the positive and negative electrodes.

In lithium metal batteries, lithium is used for negative electrodes and mechanisms are included for performing charge and discharge with deposition and dissolution of lithium. In secondary batteries, when charge-discharge rates are not controlled appropriately, sufficient durability may not be demonstrated, which also holds true for secondary batteries that are lithium metal batteries.

The invention has been devised in view of such circumstances and an object of the invention is to enable inhibition of deterioration in durability of a lithium metal battery. Further, the invention contributes to energy efficiency.

### SUMMARY OF THE INVENTION

In a control device, a control method, and a storage medium according to aspects of the invention, the following configurations are adopted.

(1) A control device according to one aspect of the invention includes a processor. The processor is configured to: acquire charge-discharge-rate information regarding a charge-discharge rate during charge or discharge of a lithium metal battery including a negative electrode containing lithium; and determine charge-discharge content of the lithium metal battery based on the charge-discharge-rate information.
(2) In the aspect of (1), the charge-discharge-rate information is discharge-rate information regarding a discharge rate of the lithium metal battery. The processor is configured to determine that a charge current is small as the charge-discharge content when a charge rate included in the charge-discharge-rate information is less than or equal to a first defined value.
(3) In the aspect of (1), the charge-discharge-rate information is discharge-rate information regarding a current discharged from the lithium metal battery. The processor is configured to determine that a discharge current is large as the charge-discharge content when a discharge rate included in the charge-discharge-rate information is less than or equal to a second defined value.
(4) In the aspect of (1), the charge-discharge-rate information is information regarding an average discharge rate or an average charge-discharge rate difference within a regulation time.
(5) In the aspect of (1), the processor is configured to acquire the charge-discharge rate based on information regarding a charge-discharge history of the lithium metal battery.
(6) In the aspect of (5), the lithium metal battery is mounted in a vehicle. The processor is configured to determine the charge-discharge content when the vehicle performs charge or discharge between the vehicle and an external apparatus.
(7) A control method according to one aspect of the invention causes a computer to: acquire charge-discharge-rate information regarding a charge-discharge rate during charge or discharge of a lithium metal battery including a negative electrode containing lithium; and determine charge-discharge content of the lithium metal battery based on the charge-discharge-rate information.
(8) A storage medium according to one aspect of the invention is a computer-readable non-transitory storage medium storing a program. The program causes a computer to: acquire charge-discharge-rate information regarding a charge-discharge rate during charge or discharge of a lithium metal battery including a negative electrode containing lithium; and determine charge-discharge content of the lithium metal battery based on the charge-discharge-rate information.

According to the aspects of (1) to (8), it is possible to inhibit deterioration in durability of a lithium metal battery.

### BRIEF DESCRIPTION OF THE DRAWINGS

FIG. 1 is a diagram showing an example of a configuration of a vehicle M in which a control device 100 is mounted according to an embodiment.

FIG. 2 is a diagram showing an example of a configuration of the control device 100.

FIG. 3 is a diagram showing an example of a visualized first reference control map 121 and first control map 122.

FIG. 4 is a diagram showing an example of a visualized second reference control map 123 and second control map 124.

FIG. 5 is a flowchart showing an example of a process of the control device 100.

### DETAILED DESCRIPTION OF THE INVENTION

Hereinafter, embodiments of a control device, a control method, and a storage medium according to the invention will be described with reference to the drawings.

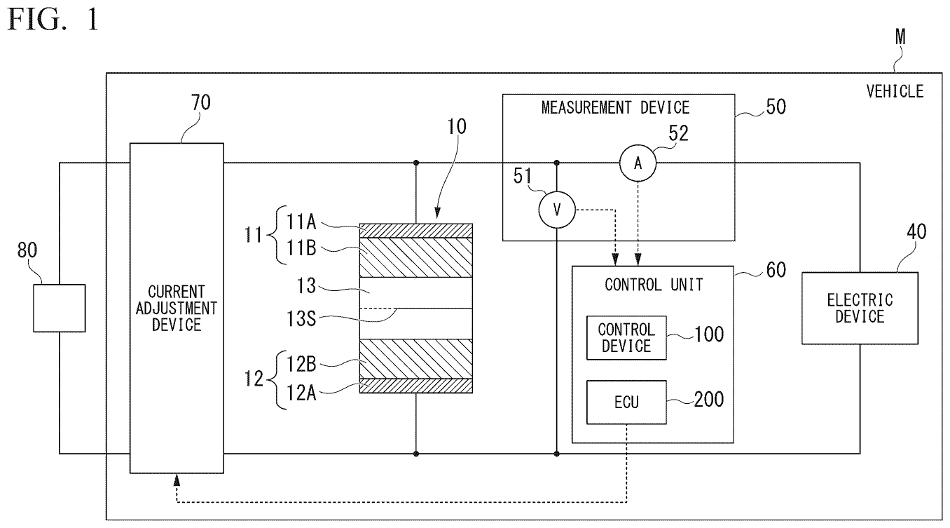

FIG. 1 is a diagram showing an example of a configuration of a vehicle M in which a control device 100 is mounted according to an embodiment. The control device 100 according to the embodiment controls a charge amount or a discharge amount of a current supplied to a lithium metal battery 10 mounted in the vehicle M. The lithium metal battery 10 includes a negative electrode containing lithium. The lithium metal battery 10 is a secondary battery capable of performing charge or discharge.

The vehicle M includes so-called vehicle to home (V2H) or vehicle to X (V2X). The vehicle M is capable of performing charge or discharge between the vehicle M and an external apparatus such as a charge or discharge facility 80 or the like. The charge or discharge facility 80 transmits a V2H request to the vehicle M when charge or discharge with the vehicle M is started. The vehicle M starts the charge or discharge with the charge or discharge facility 80 by acquiring the V2H request.

The charge or discharge facility 80 discharges a current to the lithium metal battery 10 mounted in the vehicle M to charge the lithium metal battery 10. A current adjustment device 70 mounted in the vehicle M converts an alternating-current current from the charge or discharge facility 80 into a direct-current current and drops the current to charge the lithium metal battery 10. The lithium metal battery 10 mounted in the vehicle M discharges a current to charge the charge or discharge facility 80. The current adjustment device 70 mounted in the vehicle M converts a direct-current current discharged by the lithium metal battery 10 into an alternating-current current and boosts the current to charge the charge or discharge facility 80.

In the vehicle M, in addition to the lithium metal battery 10, an electric device 40, a measurement device 50, a control unit 60, and the current adjustment device 70 are mounted. The measurement device 50 includes, for example, a voltage detector 51 and a current detector 52. The control unit 60 includes, for example, the control device 100 and an electronic control unit (ECU) 200.

The lithium metal battery 10 is, for example, a semisolid battery. The lithium metal battery 10 includes, for example, a positive electrode 11, a negative electrode 12, and an electrolyte 13. The positive electrode 11 includes, for example, a positive electrode collector 11A and a positive electrode active material layer 11B. The positive electrode collector 11A is formed of, for example, an aluminum collection foil or the like. The positive electrode active material layer 11B is formed of, for example, a lithium cobalt oxide layer or the like.

The negative electrode 12 includes, for example, a negative electrode collector 12A and a negative electrode active material layer 12B. The negative electrode collector 12A is formed of, for example, a copper collection foil or the like. The negative electrode active material layer 12B is formed of, for example, a metallic lithium layer. The electrolyte 13 is a semisolid electrolyte containing lithium ions Li+. The electrolyte 13 is partitioned into the positive electrode 11 and the negative electrode 12 by a separator 13S.

The lithium ions Li+ flow from the negative electrode active material layer 12B to the positive electrode 11 through the separator 13S at a discharge time at which the lithium metal battery 10 supplies power to the electric device 40 mounted in the vehicle M. The lithium ions Li+ flow and electrons e flow from the negative electrode 12 through a circuit of the electric device 40 to the positive electrode 11. When the lithium ions Li+ and the electrons e flow, a current flows from the positive electrode 11 to the negative electrode 12 to discharge the lithium metal battery 10. In the negative electrode active material layer 12B, metallic lithium dissolves as the lithium metal battery 10 discharges.

The lithium metal battery 10 is charged by the current adjustment device 70 located outside of the vehicle M. The current adjustment device 70 is provided in a home of an owner of the vehicle M, a charge station, or the like. The lithium ions Li+ flow from the positive electrode active material layer 11B through the separator 13S to the negative electrode 12 at a charge time.

The lithium ions Li+ flow and the electrons e flow from the positive electrode 11 through the charge or discharge facility 80 to the negative electrode 12. The flow of the lithium ions Li+ and the electrons e causes flow of a current from the negative electrode 12 to the positive electrode 11 to charge the lithium metal battery 10. In the negative electrode active material layer 12B, metallic lithium is deposited as the lithium metal battery 10 is charged.

The electric device 40 is mounted in the vehicle M and includes various devices to which power is supplied by the lithium metal battery 10. The electric device 40 includes, for example, a drive motor that drives the vehicle M, an air conditioning control device that controls air conditioning inside the vehicle M, and a monitor that displays an image for supplying various types of information to a passenger.

The voltage detector 51 in the measurement device 50 detects a voltage value of a voltage between terminals of the lithium metal battery 10. The voltage detector 51 outputs the detected voltage value to the control device 100 of the control unit 60. The current detector 52 detects a current value of a current flowing from the positive electrode 11 to the negative electrode 12 of the lithium metal battery 10. The current detector 52 outputs the detected current value to the control device 100.

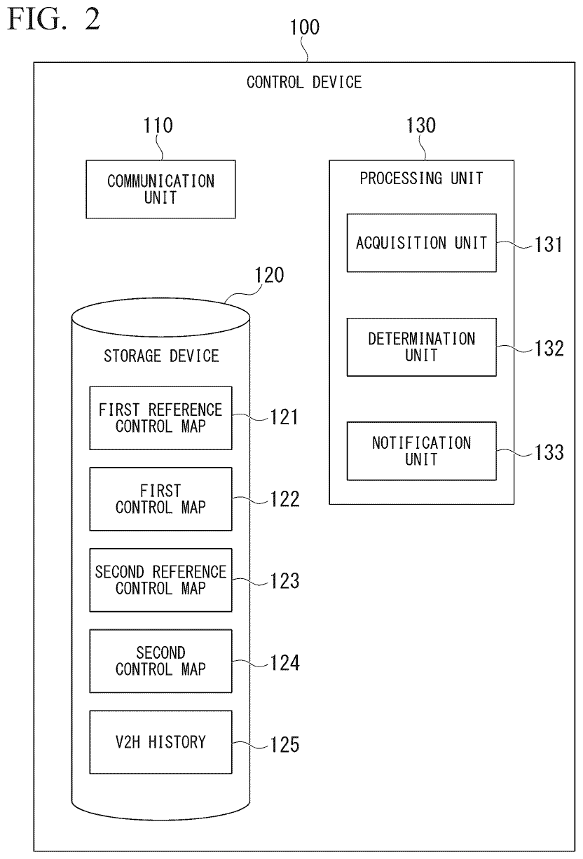

FIG. 2 is a diagram showing an example of a configuration of the control device 100. The control device 100 includes a communication unit 110, a storage unit 120, and a processing unit 130. The communication unit 110 transmits and receives a signal to and from the control device 100 and an external device. The communication unit 110 transmits a current supply signal generated by the processing unit 130 to an alternating-current power supply 20. The communication unit 110 receives a current signal transmitted by an ammeter 30. The transmission and reception performed by the communication unit 110 may be wired communication via a wiring or may be wireless communication via a network.

The storage unit 120 is, for example, a hard disk drive or a flash memory. The storage unit 120 may be a drive device externally attached to the control device 100. The storage unit 120 includes, for example, a first reference control map 121, a first control map 122, a second reference control map 123, a second control map 124, and a V2H history 125.

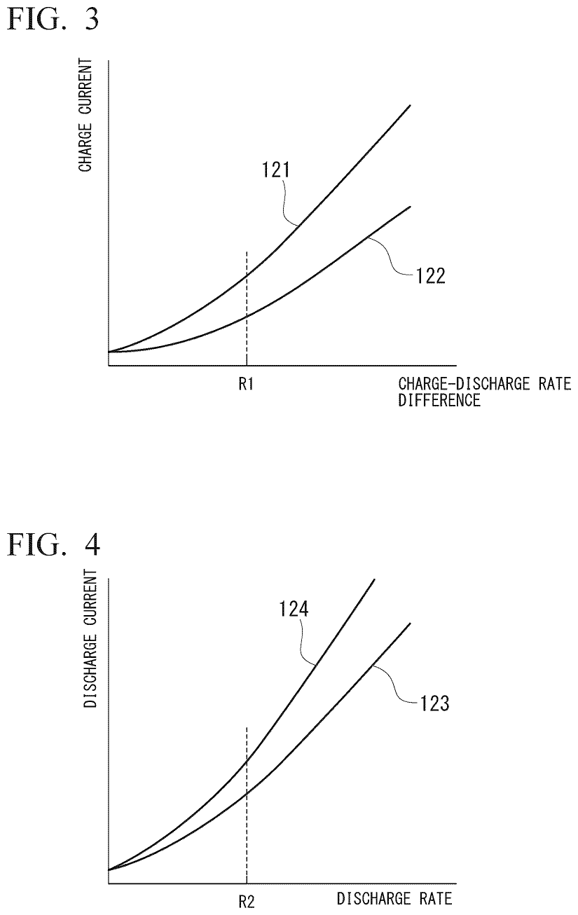

FIG. 3 is a diagram showing an example of the visualized first reference control map 121 and first control map 122. Both the first reference control map 121 and the first control map 122 are, for example, maps indicating an amount of a charge current in accordance with a charge-discharge rate difference at the time of charge of a lithium metal battery. The first control map 122 is a map generated such that a charge current is less than that of the first reference control map 121.

The V2H history 125 includes information regarding a history of charge or discharge performed between the lithium metal battery 10 and an external apparatuses by the lithium metal battery 10 by V2H formed by an external apparatus such as the charge or discharge facility 80 of the vehicle M. In the vehicle M, the V2H history 125 is updated whenever charge or discharge is performed by V2H. The V2H history 125 is an example of a charge-discharge history.

FIG. 4 is a diagram showing an example of the visualized second reference control map 123 and second control map 124. Both the second reference control map 123 and the second control map 124 are, for example, maps indicating an amount of a discharge current in accordance with a discharge rate at the time of discharge of the lithium metal battery. The second control map 124 is a map generated such that a discharge current is greater than that of the second reference control map 123.

The processing unit 130 includes, for example, an acquisition unit 131, a determination unit 132, and a notification unit 133. The constituent elements are implemented, for example, by causing a hardware processor such as a central processing unit (CPU) to execute a program (software). Some or all of the constituent elements may be implemented by hardware (including circuitry) such as a large scale integration (LSI), an application specific integrated circuit (ASIC), a field-programmable gate array (FPGA), or a graphics processing unit (GPU) or may be implanted by software and hardware in cooperation.

The program may be stored in advance in the storage unit 120 (a storage device including a non-transitory storage medium) such as an HDD or a flash memory or may be stored in a detachably mounted storage medium (non-transitory storage medium) such as a DVD or a CD-ROM by installing the storage medium in a drive device.

The acquisition unit 131 acquires a V2H request transmitted by the charge or discharge facility 80. The acquisition unit 131 acquires a voltage value output by the voltage detector 51 and a current value output by the current detector 52. The acquisition unit 131 adds the acquired voltage value and current value to the V2H history 125 stored in the storage unit 120. The acquisition unit 131 updates the V2H history 125 by adding the voltage value and the current value.

The acquisition unit 131 calculates amounts (current values) of a charge current and a discharge current of the lithium metal battery 10 and a difference between the charge current and the discharge current based on detection results of the voltage detector 51 and the current detector 52. Furthermore, the acquisition unit 131 acquires the amounts of the charge current and the discharge current and the difference between the charge current and the discharge current as charge-discharge-rate information regarding the charge-discharge rate during charge or discharge of the lithium metal battery 10. The charge-discharge rate includes a discharge rate and a charge-discharge rate difference, and the charge and discharge-rate information includes discharge-rate information and charge-discharge rate difference information. Instead of the charge-discharge rate difference, a charge rate may be used. The charge-discharge-rate information is information regarding an average discharge rate or an average charge-discharge rate difference within a regulation time. The regulation time may be determined during an appropriate time.

The determination unit 132 determines charge-discharge content of the lithium metal battery 10 based on the charge-discharge-rate information acquired by the acquisition unit 131. The determination unit 132 determines that a charge current is small as charge content, for example, when the charge-discharge rate difference included in the charge-discharge rate difference information is less than or equal to a first defined value R1. The determination unit 132 determines that a discharge current is large as discharge content, for example, when a discharge rate included in the discharge-rate information is less than or equal to a second defined value R2.

Based on, for example, the charge-discharge rate difference included in the charge-discharge rate difference information acquired by the acquisition unit 131, the determination unit 132 selects a control map referred to at the time of a request for a charge current as a recommended-charge-discharge control map. For example, when the charge-discharge rate difference is less than or equal to the first defined value R1, the determination unit 132 selects the first control map 122, refers to the charge-discharge rate difference from the first control map 122, and determines a charge current therefrom. For example, when the charge-discharge rate difference exceeds the first defined value R1, the determination unit 132 selects the first reference control map 121, refers to the charge-discharge rate difference from the first reference control map 121, and determines a charge current therefrom.

Based on, for example, the discharge rate included in the discharge-rate information acquired by the acquisition unit 131, the determination unit 132 selects a control map referred to at the time of a request for a discharge current as a recommended-charge-discharge control map. For example, when the discharge rate exceeds the second defined value R2, the determination unit 132 selects the second control map 124, refers to the discharge rate from the second control map 124, and determines a discharge current therefrom. For example, when the discharge rate is less than or equal to the second defined value R2, the determination unit 132 selects the second reference control map 123, refers to the discharge rate from the second reference control map 123, and determines a charge current therefrom.

For example, the determination unit 132 determines the charge-discharge content, for example, when the charge or discharge of the vehicle M with an external apparatus such as the charge or discharge facility 80 is performed. For example, when charge or discharge is repeated by a defined current amount or more in V2H, the determination unit 132 determines the charge-discharge content. A defined current amount or a repetition frequency of the charge or discharge may be determined appropriately.

For example, the determination unit 132 determines a discharge current when the lithium metal battery 10 of the vehicle M discharges a current to the charge or discharge facility 80. For example, the determination unit 132 determines a charge current when the lithium metal battery 10 of the vehicle M is charged with a current discharged by the charge or discharge facility 80. The discharge current and the charge current may be defined as a current value, but may be defined as a current amount.

The notification unit 133 notifies an ECU 200 of the charge current or the discharge current determined by the determination unit 132. The ECU 200 generates current value information regarding a current value of charge or discharge of the lithium metal battery 10 based on the charge current and the discharge current of which the notification unit 133 notifies. The ECU 200 transmits the generated current value information to the current adjustment device 70.

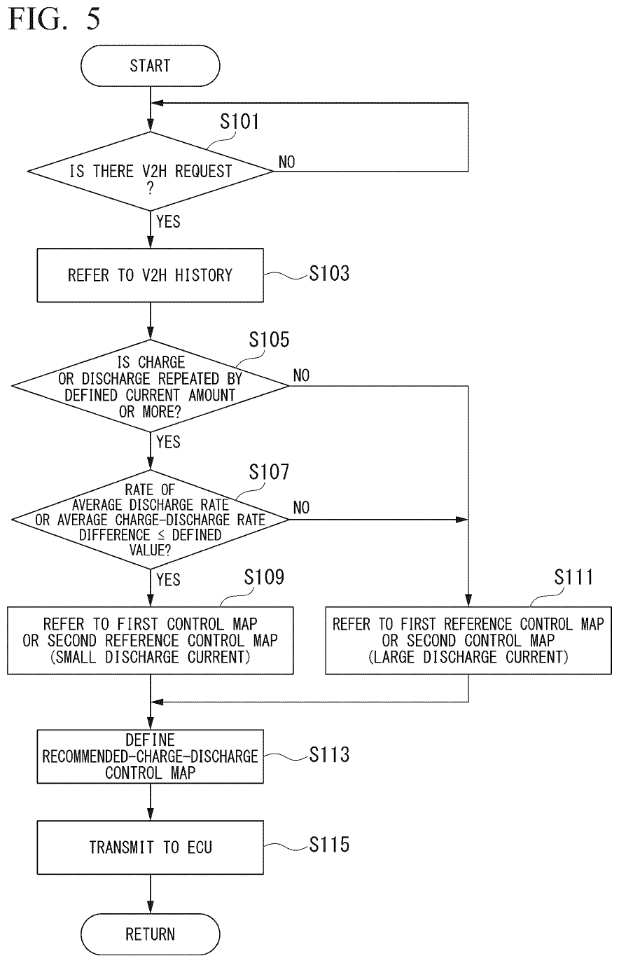

Next, a process in the control device 100 according to the embodiment will be described. FIG. 5 is a flowchart showing an example of a process of the control device 100. A process shown in FIG. 5 is performed, for example, after the vehicle M is connected to the charge or discharge facility 80. In the control device 100, it is first determined whether the acquisition unit 131 acquires a charge or discharge request (step S101).

When it is determined that a V2H request is not acquired, the acquisition unit 131 repeats the process of step S101. When it is determined that the V2H request is acquired, the acquisition unit 131 refers to the charge-discharge history stored in the storage unit 120 (step S103) and determines whether the charge or discharge is repeated by a defined current amount or more (step S105).

When the acquisition unit 131 determines that the charge or discharge is not repeated by the defined current amount or more, the control device 100 ends the process shown in FIG. 5. When it is determined that the charge or discharge is repeated by the defined current amount or more, the acquisition unit 131 determines whether the average discharge rate or the average charge-discharge rate difference is less than or equal to a defined value (step S107). Here, when the lithium metal battery 10 is being discharged, it is determined whether the average discharge rate is less than or equal to the first defined value R1. When the lithium metal battery 10 is being charged, it is determined that the average charge-discharge rate difference is less than or equal to the second defined value R2.

When the acquisition unit 131 determines that the average discharge rate or the average charge-discharge rate difference is less than or equal to the defined value, the determination unit 132 selects a control map (the first control map 122 or the second reference control map 123) in which the charge current and the discharge current becomes small as a recommended-charge-discharge control map (step S109). When the acquisition unit 131 determines that the average discharge rate or the average charge-discharge rate difference exceeds the defined value, the determination unit 132 selects a control map (the first reference control map 121 or the second control map 124) in which the charge current and the discharge current becomes large as a recommended-charge-discharge control map (step S111).

Subsequently, the determination unit 132 defines the selected recommended-charge-discharge control map (step S113), refers to the discharge rate or the charge-discharge rate difference in the recommended-charge-discharge control map, and calculates the charge current and the discharge current (step S113). The notification unit 133 generates current value information based on the charge current and the discharge current determined by the determination unit 132 and transmits the current value information to the ECU 200 (step S115). In this way, the control device 100 ends the process shown in FIG. 5.

The ECU 200 controls the current adjustment device 70 based on the current value information transmitted by the notification unit 133 of the control device 100 such that current values of the charge current and the discharge current of a current with which the lithium metal battery 10 is charged or discharged are adjusted. Under the control of the ECU 200, the lithium metal battery 10 is charged and discharged with the charge current and the discharge current of the current value adjusted by the current adjustment device 70.

The control device 100 according to the embodiment determines the charge-discharge content for the lithium metal battery 10 based on the charge-discharge rate during charge or discharge of the lithium metal battery 10. For example, when the charge rate is less than or equal to the first defined value, the control device 100 determines that the charge current is small. When the charge-discharge rate exceeds the second defined value, the control device 100 determines that the discharge current is large. Accordingly, since low-rate charge and high-rate discharge can be implemented, it is possible to inhibit deterioration in the lithium metal battery 10 efficiently.

The above-described embodiment can be expressed as follows:

A control device includes: a storage medium configured to store computer-readable instruction; and a processor connected to the storage medium.

The processor is configured to execute the computer-readable instruction such that a computer acquires charge-discharge-rate information regarding a charge-discharge rate during charge or discharge of a lithium metal battery including a negative electrode containing lithium, and determines charge-discharge content of the lithium metal battery based on the charge-discharge-rate information.

While preferred embodiments of the invention have been described and illustrated above, it should be understood that these are exemplary of the invention and are not to be considered as limiting. Additions, omissions, substitutions, and other modifications can be made without departing from the spirit or scope of the invention. Accordingly, the invention is not to be considered as being limited by the foregoing description, and is only limited by the scope of the appended claims.

What is claimed is:

1. A control device comprising a processor, the processor being configured to:
acquire charge-discharge-rate information regarding a charge-discharge rate during charge or discharge of a lithium metal battery including a negative electrode containing lithium; and
determine charge-discharge content of the lithium metal battery based on the charge-discharge-rate information.

2. The control device according to claim 1, wherein
the charge-discharge-rate information is discharge-rate information regarding a discharge rate of the lithium metal battery, and
the processor is configured to determine that a charge current is small as the charge-discharge content when a charge rate included in the charge-discharge-rate information is less than or equal to a first defined value.

3. The control device according to claim 1, wherein
the charge-discharge-rate information is discharge-rate information regarding a current discharged from the lithium metal battery, and
the processor is configured to determine that a discharge current is large as the charge-discharge content when a discharge rate included in the charge-discharge-rate information is less than or equal to a second defined value.

4. The control device according to claim 1, wherein
the charge-discharge-rate information is information regarding an average discharge rate or an average charge-discharge rate difference within a regulation time.

5. The control device according to claim 1, wherein
the processor is configured to acquire the charge-discharge rate based on information regarding a charge-discharge history of the lithium metal battery.

6. The control device according to claim 1, wherein
the lithium metal battery is mounted in a vehicle, and
the processor is configured to determine the charge-discharge content when the vehicle performs charge or discharge between the vehicle and an external apparatus.

7. A control method causing a computer to:
acquire charge-discharge-rate information regarding a charge-discharge rate during charge or discharge of a lithium metal battery including a negative electrode containing lithium; and
determine charge-discharge content of the lithium metal battery based on the charge-discharge-rate information.

8. A computer-readable non-transitory storage medium storing a program, the program causing a computer to:
acquire charge-discharge-rate information regarding a charge-discharge rate during charge or discharge of a lithium metal battery including a negative electrode containing lithium; and
determine charge-discharge content of the lithium metal battery based on the charge-discharge-rate information.
